(19) United States
(12) Patent Application Publication
(10) Pub. No.: US 2009/0066473 A1
(43) Pub. Date: Mar. 12, 2009

(54) COMMISSIONING WIRELESS NETWORK DEVICES ACCORDING TO AN INSTALLATION PLAN

(75) Inventor: Paul R. Simons, Redhill (GB)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/817,878

(22) PCT Filed: Mar. 8, 2006
(86) PCT No.: PCT/IB2006/050721

§ 371 Date: Sep. 26, 2008

(30) Foreign Application Priority Data
Mar. 11, 2005 (EP) 05101930.5

(51) Int. Cl. G05B 23/02; H04B 7/00

(52) U.S. Cl. 340/3.1; 455/41.2

(57) ABSTRACT

A method for commissioning installed building service devices comprises establishing wireless communication between plural building service devices L1, L2, E1, E2, 2, 3 to determine spatial positions of each device relative to at least three reference nodes G1, G2, G3 by triangulation of the signal. The coordinates of the determined spatial positions of each device are transmitted to a building services commissioning system, which generates a spatial position map of said devices. This map is then compared with a building services plan to obtain configuration data for each said device. Based on the configuration data, configuration commands are issued to each device to commission the system.

The present invention relates to methods and apparatus for commissioning wireless network devices, such as wirelessly controlled lighting systems and associated switching nodes, in a building.

Lighting control for large buildings is generally handled by a building management system (BMS). A wire bus is usually used to connect each light in a daisy chain fashion back to the BMS. The BMS monitors and allows control of the lights remotely, e.g. by appropriately placed motion sensors, switches and other switching nodes. It collects statistics on light and power usage and can identify failing lights, or lights that are nearing the end of their working life. The BMS can be used to automatically notify maintenance teams when service is required.

Lights are installed in a large building to a plan that specifies each light or device type, its position and its connection to the wire control bus. The installation is performed by an electrician. However, the identity of the light is not known to the BMS. A specialist is generally used to complete the installation in a commissioning operation. This commissioning operation is typically done one floor at a time. A test signal is often used to cycle the power level of each light in turn. The specialist then walks around the building until the light is identified and matched to the plan. This is repeated until all lights are identified. It is then possible to assign each lighting unit to one or more relevant controllers.

A significant disadvantage that remains in the prior art is that the commissioning process is time-consuming and can interfere with the ability of other contractors on a building site to proceed with their work. Another disadvantage is that the task of commissioning is a skilled job and therefore relatively high cost and susceptible to errors.

It would be highly desirable for such lighting systems to have a ‘plug and play’ type capability so that the commissioning operation can be fully or at least partially automated.

A number of prior art documents describe techniques for locating devices within buildings. For example, US2003/0130039 describes a method for tracking gaming machines using wireless communication within a casino or hotel, as they are moved about the building. A map or graphical representation of the location of the machines may be generated and the information can be used to verify that the positions of the machines remain within compliance of gaming regulations. WO01/93434 describes techniques for blocking or enabling communication with a portable data processing device based on a triangulated position of the device determined using wireless communication. WO2004/019559 describes a system for determining the location of a transmitting device in a wireless local area network using time-difference of arrival techniques.

It is an object of the present invention to overcome or mitigate at least some of the disadvantages described above.

According to one aspect, the present invention provides a method for commissioning installed building service devices, comprising the steps of:

establishing wireless communication between building service devices to determine spatial positions of each device relative to at least three reference nodes;

transmitting the coordinates of the spatial positions of each device to a building services commissioning system;

generating a spatial position map of said devices;

comparing the map with a building services plan to obtain configuration data for each said device; and

issuing configuration commands to each device.

According to another aspect, the present invention provides a building service device commissioning apparatus comprising:

a receiver for receiving coordinates of spatial positions for each of a plurality of building service devices;

a map generator module for generating a spatial position map of all said devices from said coordinates;

a memory storing a building services plan comprising a location of each of said devices and configuration data relating thereto;

a comparator module for comparing the generated map with the building services plan to obtain configuration data for each said device; and

a configuration module for issuing configuration commands to each device.

Embodiments of the present invention will now be described by way of example and with reference to the accompanying drawings in which:

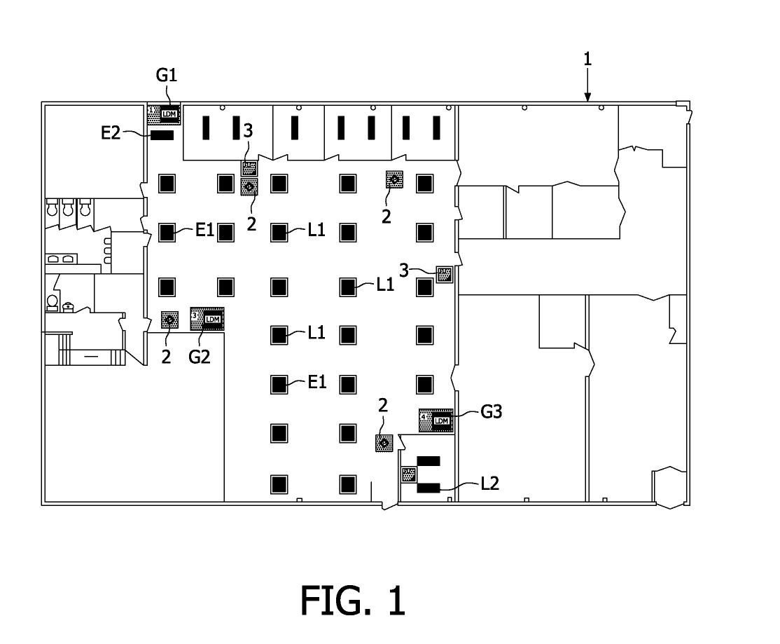

FIG. 1 shows a schematic building plan indicating the location of luminaires, switching control units and network gateways;

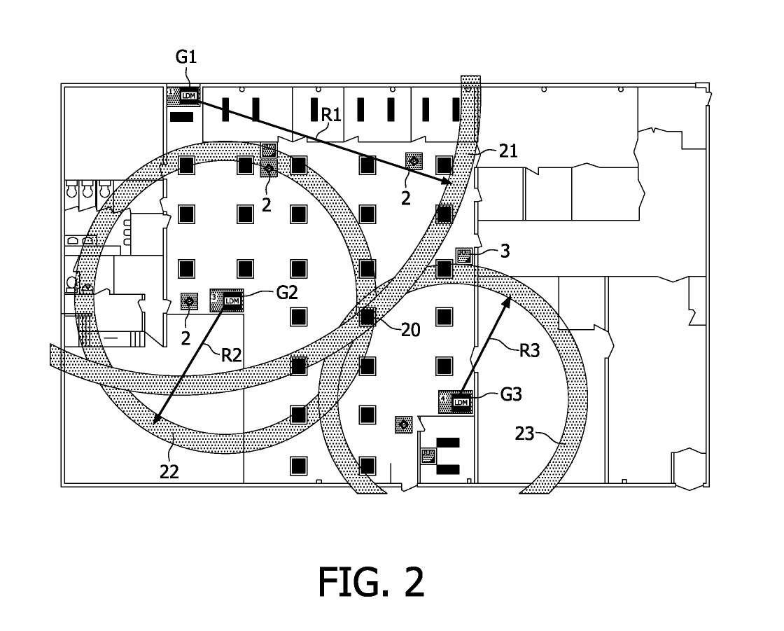

FIG. 2 shows the building plan of FIG. 1 illustrating the triangulation principles used to locate a luminaire position;

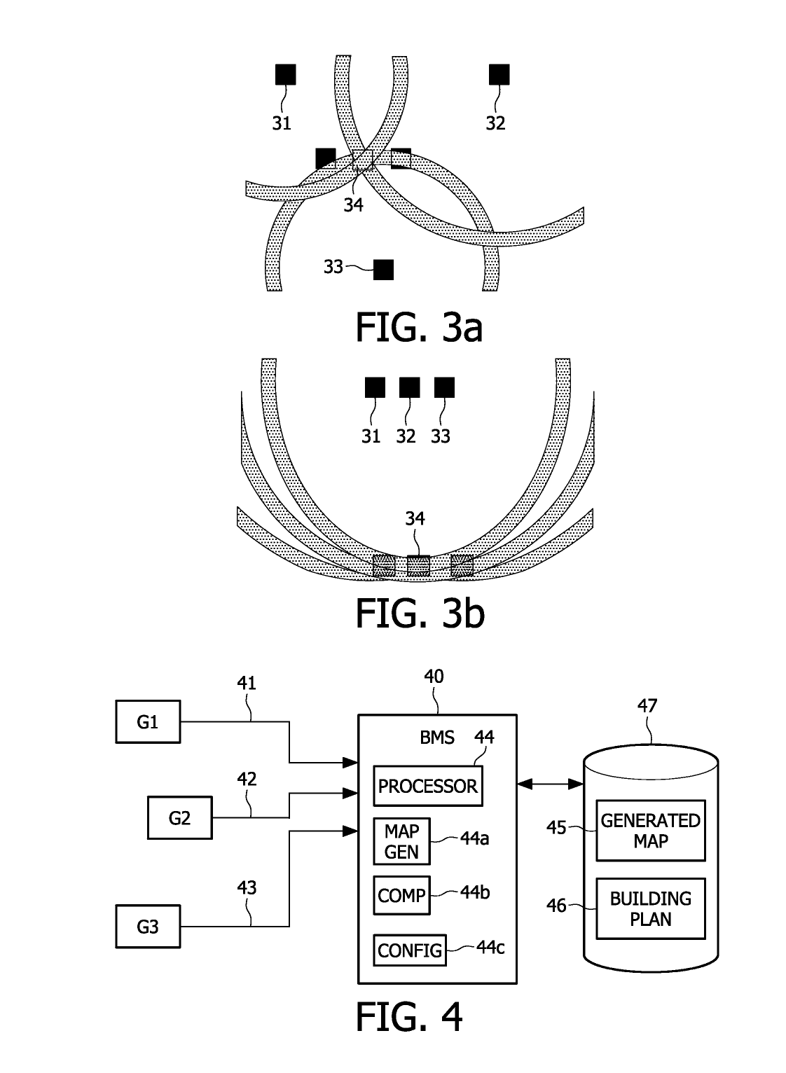

FIG. 3a shows a schematic illustration of a good triangulation geometry and FIG. 3b shows a schematic illustration of poor triangulation geometry; and

FIG. 4 shows a schematic diagram of a building management system connected to the gateways of FIG. 1.

It will be noted that although the invention will now be particularly described in connection with lighting units or luminaires in a building, the same principles apply to other remotely controllable electrical fixtures such as ventilation units, heating units, air conditioning units, blind controllers or curtain controllers etc. The expression ‘building service device’ as used herein is therefore intended to encompass all such remotely controllable or remotely monitorable electrical devices installed in a building that appear on the building services plans.

FIG. 1 shows a floor plan for a building 1 in which different types of luminaires L1, L2, E1, E2 and switching control units 2, 3 are identified within one room of the building. Of course, such a floor plan would ordinarily also extend to other rooms on that floor, and to other rooms in the building. Each of the luminaires L1, L2, E1, E2 may be connected to a common power supply and also may be connected to a building management system (not shown in FIG. 1) by either a wired or wireless bus. Selected luminaires E1, E2 may be of the emergency type for illuminating building exits. Each luminaire incorporates a transceiver capable of wirelessly communicating with other transceiver nodes around the building. Preferably, each of the luminaires and switching control units is in wireless communication with at least one gateway node G1, G2, G3. The gateway nodes are typically in wired communication directly with a BMS 40 (as shown in FIG. 4). The switching control units 2, 3 may be of any suitable type to effect control over associated luminaires, such as motion sensors or presence detectors 2, and dimmer controllers 3. Of course, the switching control units 2, 3 may also be other types (e.g. thermostats, etc) adapted for use with other types of building service devices, such as heaters and air conditioning units.

In the preferred embodiment, ZigBee is used as the wireless communications standard that is integrated into all the lights, switches, sensors and gateways installed. The gateways G1, G2, G3 communicate back to the BMS 40 over a local area network (LAN) wired backbone (41, 42, 43) or other communication system (FIG. 4). A number of gateways G1, G2, G3 are preferably used to ensure a short route back to the BMS 40, minimising the number of hops an ad-hoc network would require to cover the entire floor of the building. The gateways G1, G2, G3 preferably also provide the initial fixed reference points to enable automatic commissioning of the lighting controls although, as will become clear from the following, fixed (known) reference points are not essential for determining the spatial map since a relative map can be generated using the same triangulation techniques, which map is not anchored to a known position.

Whichever wireless communication system is used, it includes the capability to measure time-of-flight of signals sent between the wireless devices so that the distance between the respective wireless devices can be determined. Preferably, the accuracy of the system allows determination of distances within ±1 m, and more preferably within ±30 cm accuracy.

When the lights are first powered up a network is formed associating all wireless devices (lights, switches, sensors and gateways) together into a complex network, according to known protocols. This allows messages to be routed across the network over distances larger than the wireless range of any one device using ad-hoc routing. One such network is a ZigBee mesh network. Preferably, one of the gateways is configured as the network controller and all local nodes within wireless communication range join the network. The mesh routing protocol also allows nodes to join using ad-hoc routing extending the network to include all devices shown in FIG. 1.

To begin the commissioning process at least three clearly identified wireless devices of known position (absolute or relative) need to be installed to provide the fixed reference points. As stated, preferably, these three devices are the gateway devices G1, G2, G3 although any three devices could be selected. These devices all need to be in range of at least one light L1, L2, E1, E2 etc to start the process. Signals can be sent giving the position of each sending device and allowing the receiving device to measure its range using time-of-flight. Using three such measurements allows the receiving device to determine its position using well known triangulation techniques.

For example, FIG. 2 illustrates a luminaire 20 that has detected three such signals depicted as ranges R1, R2 and R3 respectively transmitted from gateways G1, G2, G3. The luminaire device 20 uses these ranges and the transmitted positions of the gateway devices G1, G2, G3 to triangulate its own position from the intersection of the respective loci 21, 22, 23 of signal ranges R1, R2, R3. This information can be compiled with the device's unique identity (e.g. IEEE address or network local address), specific device type and its calculated position and sent back to the BMS over the network. The BMS 40 can automatically compare the calculated position with the building plans, check the device type and associate a given light on the plan with its unique address.

Once the position of one light is successfully identified, it can be used as a fixed reference point of known position to help identify the positions of other lights if any exist beyond the wireless transmission range of the gateways. The process can be used to propagate over the level of a building to commission each light, sensor and switch. This process also allows the system to correct the measured position of each node identified with the position provided by the plan, which can be used to eliminate small errors. This provides the advantage that position errors are not propagated as the process is repeated when the corrected position of a node is used as a reference point.

Some lights, and particularly switches, might not be installed at a common ceiling height. It will be recognised that this could introduce triangulation errors if planar triangulation is assumed. If the differences in height dimension between devices are significant compared with the overall separation of the devices, then at least four reference points should be used to enable the third dimension to be resolved correctly.

With reference to FIG. 3, one aspect of such a local positioning system is the geometry of the positioning solution. Ideally the three or more reference devices 31, 32, 33 should be wide apart, with the device 34 with unknown position falling somewhere between them. FIG. 3a illustrates where good geometry provides a clear solution and FIG. 3b illustrates where bad geometry, which should be avoided, provides an unclear solution.

With reference to FIG. 4, having located positions of each luminaire and each switching control device (or, more generally, of every building service device) relative to the original positions of the three gateway or other devices, the BMS processor 44 may include a map generator module 44a for generating a ‘spatial position map’ 45 of the layout of the building services devices and store this map in memory 47. This can be compared directly with the building services plan 46, also stored in memory.

The commissioning process may now take place fully automatically. Firstly, the generated map 45 must be aligned to the building services plan 46. If the absolute coordinates of the three reference devices (e.g. gateways G1, G2, G3) are known, then these can be directly aligned with the building services plan. If only the relative positions of the three reference devices are known, the relative disposition of these can be used for alignment with the three corresponding gateway devices on the building services plan 46 in order to align the generated map 45 thereto.

In other circumstances, a ‘best fit’ approach could be used to align the generated map 45 and building services plan 46 for minimum variance of all devices.

In other arrangements, the generated map may be updated a number of times by reference to the building services plan during acquisition of position data for all of the wireless devices. For example, after acquisition of position data for one or more wireless devices, relative to the reference devices G1, G2, G3, the positions of those wireless devices may be compared with positions on the building services plan 46 and adjusted to correct small location errors so that they match exactly the respective positions on the building services plan. In this way, the newly acquired devices may be used as new reference devices with a high degree of confidence in their positioning. Using an iterative updating process in this manner reduces the likelihood that cumulative positioning errors could cause difficulties in matching device positions in the generated map 45 to the building services plan 46.

The processor 44 includes a comparator module 44b which is then able to relate the identity of each discovered device in the generated map 45 with a corresponding device on the building services plan 46. With this knowledge, the building management system 40 can issue configuration commands to each device that establish which lighting devices are responsive to which switching control devices. This function may be performed by a configuration module 44c.

Preferably, the building service plan 46 includes all necessary configuration data for all the devices thereon, or pointers to the relevant information in other data files. The configuration data includes data indicating a functional interaction between, for example, a luminaire or group of luminaires, and a respective switching control device or group of switching control devices. Thus, a set of luminaires may be configured to be operated by, for example, a pair of manual on-off switches, a dimmer controller and a pair of motion sensors for automatic switching. Similar principles apply for other devices, such as heaters and ventilation units. Thus, in a general sense, the configuration data comprises data indicating a functional interaction between a first group of one or more building service devices and a second group of one or more other building service devices.

After issuing all the necessary configuration commands, the building services are fully commissioned without requiring manual intervention.

From the foregoing, it will be understood that the operational steps of (i) establishing wireless communication between devices to determine the positions of the various wireless devices, (ii) generating the spatial position map 45 of the devices, (iii) comparing the map 45 with the building services plan 46 to obtain configuration data and (iv) issuing configuration commands to each device, can be performed in a sequential series of steps or as an iterative process in which the positions of some devices are determined and verified from the building services plan prior to the spatial position map 45 being updated with further devices. Configuration commands can also be issued to devices whose position has been established while the position location process for other devices is still ongoing.

Although the illustrated embodiment shows that the commissioning operation is performed by a building management system that subsequently performs monitoring and control functions of all the devices, it is possible that the commissioning system can be used in the absence of a building management system. For instance, the various luminaires L1, L2, E1, E2 may operate under the control of respective switching control devices by direct wireless control between the devices, without the necessity for a BMS. In this case, the commissioning system can be a temporary processor 44 (e.g. laptop computer) that is only used for commissioning the system.

Other embodiments are intentionally within the scope of the accompanying claims.

1. A method for commissioning installed building service devices, comprising the steps of:
establishing wireless communication between building service devices (L1, L2, E1, E2, 2, 3) to determine spatial positions of each device relative to at least three reference nodes (G1, G2, G3);
transmitting the coordinates of the spatial positions of each device to a building services commissioning system (40);
generating a spatial position map (45) of said devices;
comparing the map with a building services plan (46) to obtain configuration data for each said device; and
issuing configuration commands to each device.

2. The method of claim 1 in which the configuration data comprises data indicating a functional interaction between a first group of one or more building service devices (L1, L2, E1, E2) and a second group of one or more other building service devices (2, 3).

3. The method of claim 2 in which the first group of building service devices comprise luminaires (L1, L2, E1, E2) and the second group of building service devices comprises switching control units (2, 3).

4. The method of claim 3 in which the switching control units (2, 3) comprise any one or more of on-off switches, dimmer controllers, motion sensors and presence sensors.

5. The method of claim 2 in which the first group of building service devices comprise any one or more of heating, ventilation and air conditioning units and the second group of building service devices comprises switching control units.

6. The method of claim 1 in which the wireless communication uses radio-frequency wireless communication.

7. The method of claim 6 the wireless communication conforms to the ZigBee standard.

8. The method of claim 1 in which the spatial positions of each building service device are determined using a time of flight measurement of wireless signals between devices.

9. The method of claim 1 in which the step of comparing comprises, for every device located in the spatial position map (45), a corresponding device in the building services plan (46), and reading configuration data associated with that device from the building services plan.

10. The method of claim 1 in which the building services commissioning system forms part of a building management system (40).

11. The method of claim 10 in which the at least three reference nodes (G1, G2, G3) are gateway devices serving as nodes for direct communication with the building management system (40).

12. The method of claim 1 in which the step of comparing the spatial position map (45) with the building services plan further includes the step of correcting the coordinates of the spatial position for a device in accordance with the building services plan to facilitate more accurate spatial position determination of successive devices.

13. A building service device commissioning apparatus (40) comprising:
a receiver for receiving coordinates of spatial positions for each of a plurality of building service devices (L1, L2, E1, E2, 2, 3);
a map generator module (44a) for generating a spatial position map (45) of all said devices from said coordinates;
a memory (47) storing a building services plan (46) comprising a location of each of said devices and configuration data relating thereto;
a comparator module (44b) for comparing the generated map with the building services plan to obtain configuration data for each said device; and
a configuration module (44c) for issuing configuration commands to each device.

14. The apparatus of claim 13 in which the configuration data comprises data indicating a functional interaction between a first group of one or more building service devices (L1, L2, E1, E2) and a second group of one or more other building service devices (2, 3).

15. The apparatus of claim 14 in which the first group of building service devices comprise luminaires and the second group of building service devices comprises switching control units.

16. The apparatus of claim 15 in which the switching control units comprise any one or more of on-off switches, dimmer controllers, motion sensors and presence sensors.

17. The apparatus of claim 14 in which the first group of building service devices comprise any one or more of heating, ventilation and air conditioning units and the second group of building service devices comprises switching control units.

18. The apparatus of claim 13 in which the comparator module (44b) comprises a processor adapted to, for every device located in the spatial position map, identify a corresponding device in the building services plan, and read configuration data associated with that device from the building services plan (46).

19. The apparatus of claim 13 in which the comparator module (44b) includes a correction module for correcting the coordinates of the spatial position for a device in accordance with the building services plan (46) to facilitate more accurate spatial position determination of successive devices.

20. The apparatus of claim 13 in which the building services commissioning apparatus forms part of a building management system (40).
